(19) United States
(12) Patent Application Publication
(10) Pub. No.: US 2021/0168477 A1
(43) Pub. Date: Jun. 3, 2021

(54) PHONYS

(71) Applicant: Troy Borgen, Corona, CA (US)

(72) Inventor: Troy Borgen, Corona, CA (US)

(21) Appl. No.: 16/699,710

(22) Filed: Dec. 1, 2019

(51) Int. Cl. H04R 1/02; H04R 1/04; G06F 3/16; H04R 3/12; H04R 1/40

(52) U.S. Cl. CPC H04R 1/025; H04R 1/04; G06F 3/165; H04W 4/80; H04R 1/403; H04R 2420/09; H04R 2420/07; H04R 3/12

(57) ABSTRACT

An illustrated view of an exemplary phonys device for storing and accessing audio devices is presented. The phonys device is useful for providing a safe, quick and easily accessibility, usability and storage for clothing. The phonys device is useful for providing access to conversations, listening to music and other forms of audio entertainment while the audio device being stored in a safe and secure fashion. The clothing may be jeans, dresses, suits, etc. The audio devices may be mobile phones, music playing devices, etc.

### FIELD OF THE INVENTION

This invention relates to clothing. More particularly, it relates to jeans adapted to have audio access.

### BACKGROUND

Clothing (also known as clothes, apparel and attire is a collective term for items worn on the body. Clothing is typically made of fabrics or textiles but over time has included garments made from animal skin or other thin sheets of materials put together. The wearing of clothing is mostly restricted to human beings and is a feature of all human societies. The amount and type of clothing worn depends on gender, body type, social, and geographic considerations.

Clothing serves many purposes: it can serve as protection from the elements, rough surfaces, rash-causing plants, insect bites, splinters, thorns and prickles by providing a barrier between the skin and the environment. Clothes can insulate against cold or hot conditions, and they can provide a hygienic barrier, keeping infectious and toxic materials away from the body. Clothing also provides protection from ultraviolet radiation.

Wearing clothes is also a social norm, and being deprived of clothing in front of others may be embarrassing. Not wearing clothes in public so that genitals, breasts or buttocks are visible could be considered indecent exposure.

Jeans are a type of pants or trousers, typically made from denim or dungaree cloth. Often the term “jeans” refers to a particular style of trousers, called “blue jeans”, which were invented by Jacob W. Davis in partnership with Levi Strauss & Co. in 1871 and patented by Jacob W. Davis and Levi Strauss on May 20, 1873. Prior to the Levi Strauss patented trousers, the term “blue jeans” had been long in use for various garments (including trousers, overalls, and coats), constructed from blue-colored denim.

One type of clothing is jeans. Jeans also references a (historic) type of sturdy cloth commonly made with a cotton warp and wool weft (also known as “Virginia cloth”). Jean cloth can be entirely cotton as well, similar to denim. Originally designed for miners, modern jeans were popularized as casual wear by Marlon Brando and James Dean in their 1950s films, particularly The Wild One and Rebel Without a Cause, leading to the fabric becoming a symbol of rebellion among teenagers, especially members of the greater subculture. From the 1960s onwards, jeans became common among various youth subcultures and subsequently the wider young members the general population. Nowadays, they are one of the most popular types of especially trousers in Western culture. Historic brands include Levi's, Lee, and Wrangler.

Jeans normally have two pockets in the front and two pockets in the rear portion. The pockets are generally made to be smallish such that the pockets can be used for change, odd small items and billfolds.

A mobile phone, cell phone, cellphone, or hand phone, sometimes shortened to simply mobile, cell or just phone, is a portable telephone that can make and receive calls over a radio frequency link while the user is moving within a telephone service area. The radio frequency link establishes a connection to the switching systems of a mobile phone operator, which provides access to the public switched telephone network (PSTN). Modern mobile telephone services use a cellular network architecture, and, therefore, mobile telephones are called cellular telephones or cell phones, in North America. In addition to telephony, 2000s-era mobile phones support a variety of other services, such as text messaging, MMS, email, Internet access, short-range wireless communications (infrared, Bluetooth), business applications, video games, and digital photography. Mobile phones offering only those capabilities are known as feature phones; mobile phones which offer greatly advanced computing capabilities are referred to as smartphones.

Mobile phones and other audio devices have become common-place as they have replaced land-line phones normally found in households and are used instead of the pay-phones of the past.

Clothing has not been adapted to easily hold cellular phones and are commonly placed in one of the rear pockets or one of the front pockets of jeans, but those pockets do not sufficiently hold mobile phones. Other types of clothing generally do not accommodate audio listening devices such as mobile phones. Those people wishing to take their audio devices with them find them hard to manage storage and must put them in their hands or in a pocket book, brief case, etc.

Accordingly, in light of the foregoing, there is a need for clothing to have storing areas for audio devices as well as to have access to the features that those with audio devices use.

### BRIEF DESCRIPTION OF THE DRAWINGS

FIG. 1A is an illustrated view of an exemplary phonys device.

FIG. 1B is an illustrated view of a back of a first shoulder strap and a second shoulder strap of the exemplary phonys device shown in FIG. 1A.

FIG. 1C is an illustrated view of a front of a pocket of the exemplary phonys device shown in FIG. 1A

FIG. 1D is an illustrated view of a back of a pocket of the exemplary phonys device shown in FIG. 1A

FIG. 2 is an illustrated view of a use of the exemplary phonys device shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

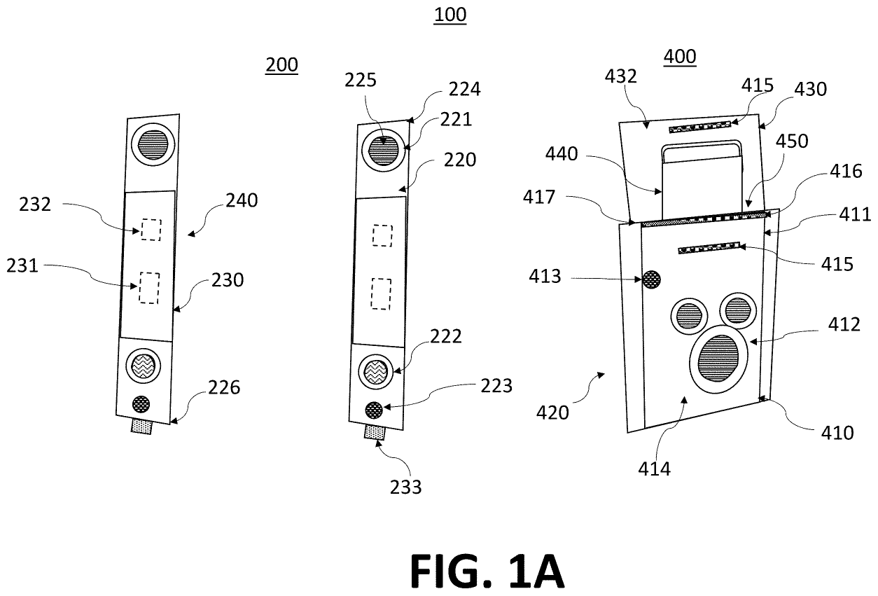

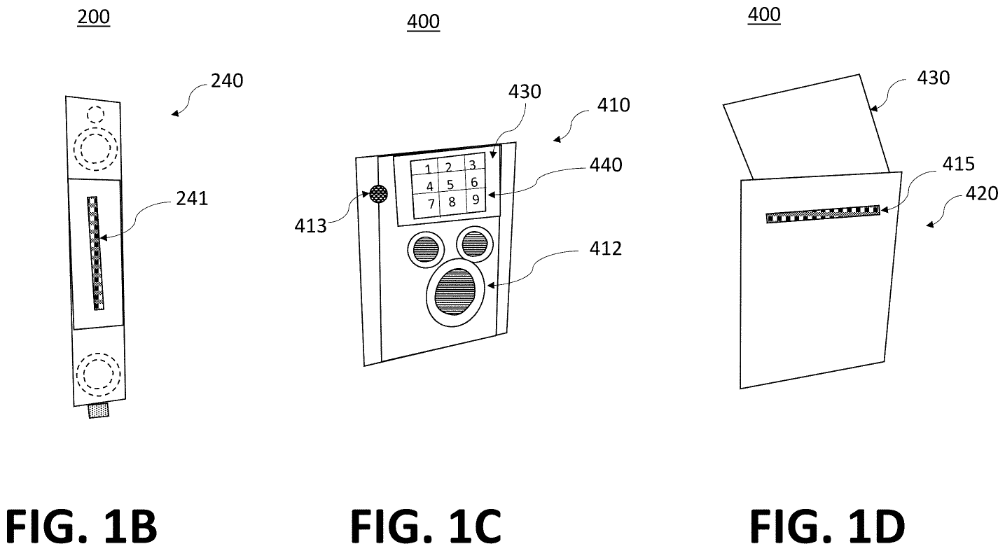

Referring to FIG. 1A, FIG. 1B, FIG. 1C and FIG. 1D, an illustrated view of an exemplary phonys device 100 for storing and accessing audio devices is presented. The phonys device 100 is useful for providing a safe, quick and easily accessibility, usability and storage for clothing. The phonys device 100 is useful for providing access to conversations, listening to music and other forms of audio entertainment while the audio device being stored in a safe and secure fashion. The clothing may be jeans, dresses, suits, etc. The audio devices may be mobile phones, music playing devices, etc.

The phonys device 100 has a two (2) shoulder straps 200 and a pocket 400.

Each of the shoulder strap 200 has a front 220, an inside 230 and a back 240. The shoulder strap 200 is preferably made of a flexible material, however other types of materials are hereby contemplated, including, but not limited to, leather, mesh, etc. The should strap 200 preferably has a length of five (5) inches, however other lengths are hereby contemplated, including, but not limited to, four (4) inches, six (6) inches, etc. The first shoulder strap 200 preferably has a width of one (1) inch, however other widths are hereby contemplated, including, but not limited to, three-fourths (0.75) inch, two (2) inches, etc.

The front 220 of the shoulder strap 200 of the phonys device 100 has a speaker 221, a microphone 222 and a control button 223.

The speaker 201 is coupled to substantially near a first end 224 of the front 220 of the shoulder strap 200. Optionally and/or additionally, the speaker 221 may have a sub-woofer 225.

The microphone 222 is coupled substantially near a second end 226 of the front 220 of the shoulder strap 200. The microphone 222 is useful for providing for receiving and sending a voice of a user of the phonys device 100.

The control button 223 is coupled significantly near the second end 226 of the front 220 of the shoulder strap 200. The control button 203 is useful for allowing the user of the phonys device 100 to accept a phone call and thus actuating the microphone 222 coupled to the front 220 of the shoulder strap 200.

The inside 230 of shoulder strap 200 has power source 231 and a transceiver 232. The power source 231 is preferably a rechargeable battery, however other types of power sources are hereby contemplated, including, but not limited to, NiCad, disposable battery, etc. The transceiver 232 is communicatively coupled to an audio device 600 (See FIG. 1D) by wireless signaling. The wireless signaling is preferably consistent with the IEEE 802.15 (Bluetooth®) standard, however other types of wireless signaling is hereby contemplated, including, but not limited to, IEEE 802.11 (WiFi®) standard, etc.

The power source 231 is electrically coupled to the control button 223, the transceiver 232, the speaker 221 and the microphone 222. The power source 231 is further coupled to a charging port 233 coupled to the first end 224 of the front 220 of the first shoulder strap 200 of the phonys device 100. The charging port 233 is preferably a USB compatible port, however other types of ports are hereby contemplated, including but not limited to, fire, etc.

The back 240 of the shoulder strap 200 has at least one first coupling device 241. The first coupling device 241 is preferably a magnet strip, however other types of coupling devices are hereby contemplated, including, but not limited to, clips, Velcro® strips, two-sided tape, etc. When being used, the first coupling device 241 is coupled to a clothing article. The first coupling device 241 is preferably coupled to each of a shoulder of the clothing article.

The inside 230 of shoulder strap 200 has power source 231 and a transceiver 232. The power source 231 is preferably a rechargeable battery, however other types of power sources are hereby contemplated, including, but not limited to, NiCad, disposable battery, etc. The transceiver 232 is communicatively coupled to an audio device 600 (See FIG. 1D) by wireless signaling. The wireless signaling is preferably consistent with the IEEE 802.15 (Bluetooth®) standard, however other types of wireless signaling is hereby contemplated, including, but not limited to, IEEE 802.11 (WiFi®) standard, etc.

The power source 231 is electrically coupled to the control button 223, the transceiver 232, the speaker 221 and the microphone 222. The power source 231 is further coupled to a charging port 233 coupled to the first end 224 of the front 220 of the shoulder strap 200 of the phonys device 100. The charging port 233 is preferably a USB compatible port, however other types of ports are hereby contemplated, including but not limited to, fire, etc.

The pocket 400 has a front 410, a back 420, a flap 430, a locking device 440 and an inside 450. The pocket 400 preferably has a length of six (6) inches, however other lengths are hereby contemplated, including, but not limited to, five (5) inches, seven (7) inches, etc. The pocket 400 preferably has a width between three and three and one-half (3-3.5) inches, however other widths are hereby contemplated, including but not limited to, two and one-half (2.5) inches, four (4) inches, etc.

The locking device 440 is coupled to an outside 431 of the flap 430. The locking device 440 is preferably a combination lock, however other types of locks are hereby contemplated, including, but not limited to, keyed lock, etc.

The front 410 of the pocket 400 having a top portion 411, a plurality of speakers 412, a closure 416 and a control button 413. The plurality of speakers 412 being coupled to a lower portion 414 of the front 410. The control button 413 being coupled near the top portion 411 of the front 410. The closure 416 being coupled to a top 417 of the front 410.

One or more of a plurality of second coupling devices 415 are coupled to the top portion 411 of the front 410 of the pocket 400. The second coupling devices 415 are preferably Velcro® strips, however other types of coupling devices are hereby contemplated, including, but not limited to, snaps, buttons, etc. At least one of the others of the plurality of second coupling devices 415 are coupled to an inside 432 of the flap 430.

The inside 420 of the pocket 400 is preferably made from a lined material, however other materials are hereby contemplated, including, but not limited to, wool, cotton, flannel, etc. The inside 420 preferably has a carbon-fiber layer.

The back 420 of the pocket 400 has at least one third coupling device 421. The third coupling device 421 is preferably a magnet strip, however other types of coupling devices are hereby contemplated, including, but not limited to, clips, Velcro® strips, two-sided tape, etc. When being used, the third coupling device 421 is coupled to a clothing article.

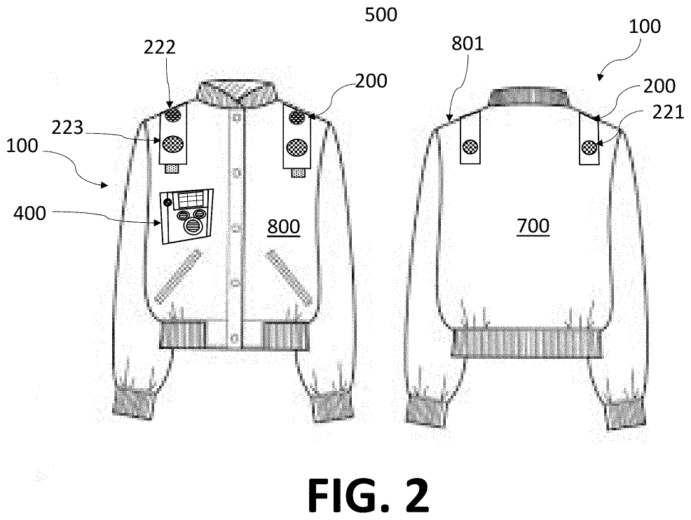

Moving now to FIG. 2, an illustrated view of a use of the exemplary phonys device 100 shown in FIG. 1A is presented.

The two (2) shoulder straps 200 are coupled to a front 800 and a back 700 of the shoulder 801 of a clothing 500. The speaker 221 of the shoulder straps 200 are configured to be on the back 700 of the clothing 500 and the microphone 222 and control button 223 are configured to be on the front 800 of the clothing 800.

The pocket 400 is configured to be coupled to the front 800 of the clothing 500, thereby allowing for easy access to the audio device 600 (not shown in FIG. 2) configured to be in the pocket 200 of the phonys device 100.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A phonys device for providing portability and security of audio devices, the device comprising:
two (2) shoulder straps, each of the shoulder straps comprising:
a front, an inside and a back;
a speaker, the speaker being coupled substantially near a first end of the front;
a microphone, the microphone being coupled near a second end of the front;
a control button, the control button being coupled between the microphone and the second end of the front;
a transceiver, the transceiver being coupled to the inside, wherein the transceiver being communicatively coupled to an audio device by a wireless communication, wherein the transceiver being communicatively coupled to the control button, wherein the transceiver being coupled to the speaker, and wherein the transceiver being coupled to the microphone;
a power source, the power source being coupled to the inside, wherein the power source being coupled to the speaker, wherein the power source being coupled to the transceiver, and wherein the transceiver being communicatively coupled to the control button;
a charging port, the charging port being coupled to the first end of the front, and wherein the charging port being coupled to the power source; and
one or more first coupling devices, the first coupling devices being coupled to the back;
a pocket, the pocket comprising:
a front, a back, an inside and a flap;
a locking device, the locking device being coupled to the flap;
a plurality of second coupling devices, at least one of the coupling devices being coupled to an inside of the flap, wherein at least one of another of the second coupling devices being coupled to a top portion of the front;
a plurality of speakers, the speakers being coupled to the front;
a control button, the power control being coupled to the front;
a power source, the power source being coupled to the inside, wherein the power source being coupled to the plurality of speakers, and wherein the power source being coupled to the control button;
one or more third coupling devices, the third coupling devices being coupled to the back.
a closure, the closure being coupled to the top portion of the pocket.

2. The device of claim 1, wherein the pocking having a length being six inches (6) inches.

3. The device of claim 1, wherein the pocket having a width being three and one-half (3.5) inches.

4. The device of claim 1, wherein the device having a height of two and one-fourth (2.25) inches.

5. The device of claim 1, wherein locking device being a keypad.

6. The device of claim 5, wherein the first coupling devices being a magnet strip.

7. The device of claim 1, wherein the third coupling devices being a Vecro® strip.

8. The device of claim 1, wherein the inside of the pocket being a lined material.

9. The device of claim 1, wherein the closure of the pocket being a zipper.

10. The device of claim 1, wherein the speaker of the shoulder straps having a sub-woofer.

11. The device of claim 1, wherein the shoulder straps having a length being five (5) inches.

12. The device of claim 1, wherein the shoulder straps having a width being one (1) inch.

13. The device of claim 1, wherein the inside of the pocket having a carbon-fiber layer.

14. The device of claim 1, wherein the shoulder straps being made of a flexible material.

15. The device of claim 1, wherein the charging port of the first shoulder strap being a USB port.

16. The device of claim 1, wherein the wireless communication being consistent with an IEEE 802.15 (Bluetooth®) standard.
